(19) United States
(12) Patent Application Publication
(10) Pub. No.: US 2025/0140922 A1
(43) Pub. Date: May 1, 2025

(54) ELECTROLYTE SOLUTION, LITHIUM-ION BATTERY, AND ELECTRONIC DEVICE

(71) Applicant: Ningde Amperex Technology Limited, Ningde (CN)

(72) Inventor: Qing XU, Ningde (CN)

(73) Assignee: Ningde Amperex Technology Limited, Ningde (CN)

(21) Appl. No.: 18/926,414

(22) Filed: Oct. 25, 2024

(30) Foreign Application Priority Data
Oct. 27, 2023 (CN) 202311412694.5

(51) Int. Cl. H01M 10/0567; H01M 10/0525

(52) U.S. Cl. CPC H01M 10/0567; H01M 10/0525; H01M 2300/0025

(57) ABSTRACT

An electrolyte solution includes an additive A and an additive B. The additive A includes at least one selected from a group consisting of a compound of Formula (I-1), a compound of Formula (I-2), or a compound of Formula (1-3). The additive B includes at least one of lithium bis(trifluoromethanesulfonyl)imide, Lithium difluoro (bisoxalato)phosphate, or lithium bis(oxalato) borate. Applying the electrolyte solution containing the additive A and the additive B to a lithium-ion battery can reduce the impedance of the lithium-ion battery and improve the low-temperature cycling performance and high-temperature storage performance of the lithium-ion battery.

### CROSS-REFERENCE TO RELATED APPLICATION

This application claims priority from Chinese Patent Application No. 202311412694.5, filed on Oct. 27, 2023, the contents of which are incorporated herein by reference in its entirety.

### TECHNICAL FIELD

This application relates to the field of electrochemical technology, and in particular, to an electrolyte solution, a lithium-ion battery, and an electronic device.

### BACKGROUND

Lithium-ion batteries are widely used in the fields such as smartphones, wearable devices, consumable unmanned aerial vehicles, and electric vehicles by virtue of advantages such as a high energy density, a long cycle life, and no memory effect. With the widespread application of lithium-ion batteries in the above fields, the market is imposing higher requirements on the performance of lithium-ion batteries. The lithium-ion batteries are required to have a broad operating temperature window and exhibit excellent electrochemical performance at normal temperature, and also exhibit good electrochemical performance at high or low temperatures. An electrolyte solution is an important component of a lithium-ion battery, and the operating temperature range of the electrolyte solution affects the impedance, low-temperature cycling performance, and high-temperature storage performance of the lithium-ion battery.

### SUMMARY

An objective of this application is to provide an electrolyte solution, a lithium-ion battery, and an electronic device to reduce the impedance of the lithium-ion battery and improve the low-temperature cycling performance and high-temperature storage performance of the lithium-ion battery. Specific technical solutions are as follows:

A first aspect of this application provides an electrolyte solution. The electrolyte solution includes an additive A and an additive B. The additive A includes at least one selected from a group consisting of a compound of Formula (I-1), a compound of Formula (I-2), or a compound of Formula (I-3):

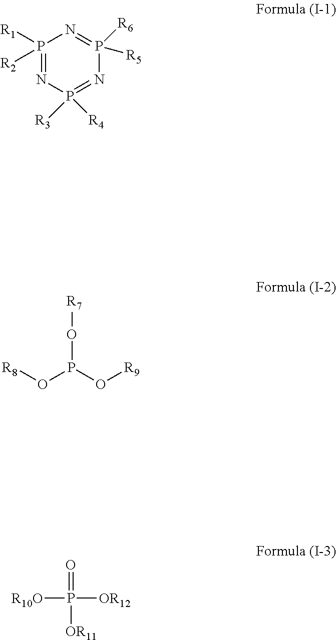

In the formulas above, R₁, R₂, R₃, R₄, R₅, and R₆ each are independently selected from a halogen atom, a C₁ to C₁₂ alkyl or a C₁ to C₁₂ alkoxyl; R₇, R₈, and R₉ each are independently selected from a hydrogen atom, a halogen atom, a silyl, a cyano group, an acyloxy, a sulfonyl, a C₁ to C₁₀ alkyl, a C₁ to C₁₀ haloalkyl, a C₂ to C₁₀ alkenyl, a C₂ to C₁₀ haloalkenyl, a C₂ to C₁₀ alkynyl, or a C₂ to C₁₀ haloalkynyl; and R₁₀, R₁₁, and R₁₂ each are independently selected from a hydrogen atom, a halogen atom, a C₁ to C₇ alkyl, a C₁ to C₇ haloalkyl, a C₂ to C₇ alkenyl, a C₂ to C₇ haloalkenyl, a C₂ to C₇ alkynyl, a C₂ to C₇ haloalkynyl, a C₆ to C₁₀ aryl, or a C₆ to C₁₀ haloaryl. The additive B includes at least one of lithium bis(trifluoromethanesulfonyl)imide, Lithium difluoro (bisoxalato)phosphate, or lithium bis(oxalato) borate. The electrolyte solution can form a cathode electrolyte interface (CEI) film and an anode electrolyte interface (SEI) film that contain diverse constituents and that are of a moderate thickness, enhance the stability of the cathode interface and the anode interface, and can function at both high and low temperatures, thereby improving the low-temperature cycling performance and high-temperature storage performance of the lithium-ion battery. In addition, the additive A and the additive B can jointly promote the migration of lithium ions, thereby reducing the impedance of the lithium-ion battery.

In some embodiments of this application, based on a mass of the electrolyte solution, a mass percentage of the additive A is W₁, and a mass percentage of the additive B is W₂, satisfying: 0.01≤W₁/W₂≤80, 0.01%≤W₁≤5%, and 0.01%≤W₂≤ 6%. By regulating the values of the W₁/W₂ ratio, W₁, and W₂ to fall within the above ranges, this application can exert the synergistic effect of the additive A and the additive B, thereby reducing the impedance of the lithium-ion battery and improving the low-temperature cycling performance and high-temperature storage performance of the lithium-ion battery.

In some embodiments of this application, the compound of Formula (I-1) includes at least one of the following compounds:

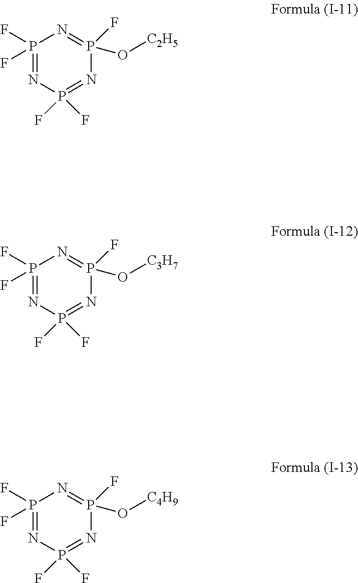

Meeting the above condition is conducive to further reducing the impedance of the lithium-ion battery and improving the low-temperature cycling performance and high-temperature storage performance of the lithium-ion battery.

In some embodiments of this application, the compound of Formula (I-2) includes at least one of the following compounds:

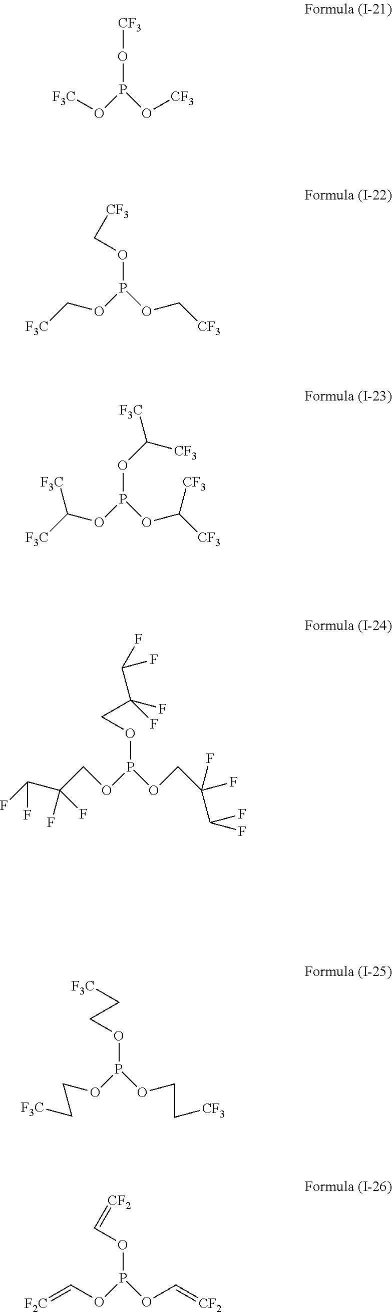

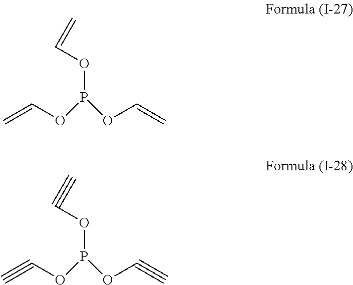

Meeting the above condition is conducive to further reducing the impedance of the lithium-ion battery and improving the low-temperature cycling performance and high-temperature storage performance of the lithium-ion battery.

In some embodiments of this application, the compound of Formula (I-3) includes at least one of trimethyl phosphate, triethyl phosphate, triphenyl phosphate, tris(trifluoroethyl) phosphate, tris(2-tris(hexafluoroisopropyl) phosphate, trifluoromethylallyl)phosphate, tris(2-trifluoromethyl-but-3-ynyl)phosphate, or difluoroethyl trifluoroethyl hexafluoroisopropyl phosphate. Meeting the above condition is conducive to further reducing the impedance of the lithium-ion battery and improving the low-temperature cycling performance and high-temperature storage performance of the lithium-ion battery.

In some embodiments of this application, based on a mass of the electrolyte solution, the additive A satisfies at least one of the following characteristics: (1) a mass percentage of the compound of Formula (I-1) is 0.01% to 3%; (2) a mass percentage of the compound of Formula (I-2) is 0.01% to 2%; (3) a mass percentage of the compound of Formula (I-3) is 0.01% to 3%. Letting the electrolyte solution contain the additive A and regulating the mass percentage of the compound to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, based on a mass of the electrolyte solution, the additive B satisfies at least one of the following characteristics: (1) a mass percentage of the lithium bis(trifluoromethanesulfonyl)imide is 0.01% to 4%; (2) a mass percentage of the Lithium difluoro (bisoxalato)phosphate is 0.01% to 6%; or (3) a mass percentage of the lithium bis(oxalato) borate is 0.01% to 5%. Letting the electrolyte solution contain the additive B and regulating the mass percentage of the compound to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the electrolyte solution satisfies one of the following characteristics: (1) the additive A includes the compound of Formula (I-1) and the compound of Formula (I-2); or (2) the additive A includes the compound of Formula (I-2) and the compound of Formula (I-3). Letting the electrolyte solution contain the above types of additive A can further alleviate the performance fluctuation of the lithium-ion battery at different temperatures and make the lithium-ion battery work in a broader operating temperature window, thereby favorably endowing the lithium-ion battery with good low-temperature cycling performance and high-temperature storage performance in addition to a relatively low impedance.

In some embodiments of this application, the electrolyte solution satisfies one of the following characteristics: (1) the additive B includes lithium bis(trifluoromethanesulfonyl)imide and Lithium difluoro (bisoxalato)phosphate; (2) the additive B includes lithium bis(trifluoromethanesulfonyl)imide and lithium bis(oxalato) borate; (3) the additive B includes Lithium difluoro (bisoxalato)phosphate and lithium bis(oxalato) borate; or (4) the additive B includes lithium bis(trifluoromethanesulfonyl)imide, Lithium difluoro (bisoxalato)phosphate, and lithium bis(oxalato) borate. Letting the electrolyte solution contain the above types of additive B can further enhance the stability of the cathode electrolyte interface, thereby further reducing the impedance of the lithium-ion battery and improving the low-temperature cycling performance and high-temperature storage performance of the lithium-ion battery.

A second aspect of this application provides a lithium-ion battery. The lithium-ion battery includes a positive electrode plate, a negative electrode plate, and an electrolyte solution. The electrolyte solution is the electrolyte solution disclosed in the first aspect of this application. The positive electrode plate includes a positive active material layer. The positive active material layer includes a positive active material. The positive active material includes lithium nickel cobalt manganese oxide. A specific surface area (BET) of the lithium nickel cobalt manganese oxide is 0.1 m²/g to 2.0 m²/g. Meeting the above conditions is conducive to enhancing the synergistic effect between the positive active material and the electrolyte solution additive A and additive B, thereby further reducing the impedance of the lithium-ion battery and improving the low-temperature cycling performance and high-temperature storage performance of the lithium-ion battery.

In some embodiments of this application, the lithium-ion battery satisfies at least one of the following characteristics: (1) a mass percentage of the additive B is 0.01% to 4%; or (2) a specific surface area of the lithium nickel cobalt manganese oxide is 0.1 m²/g to 1.8 m²/g. Meeting the above condition is conducive to further reducing the impedance of the lithium-ion battery and improving the low-temperature cycling performance and high-temperature storage performance of the lithium-ion battery.

A third aspect of this application provides an electronic device. The electronic device includes the lithium-ion battery disclosed in the second aspect of this application.

Some of the beneficial effects of this application are as follows:

This application provides an electrolyte solution. The electrolyte solution includes an additive A and an additive B. The additive A includes at least one selected from a group consisting of a compound of Formula (I-1), a compound of Formula (I-2), or a compound of Formula (I-3). The additive B includes at least one of lithium bis(trifluoromethanesulfonyl)imide, Lithium difluoro (bisoxalato)phosphate, or lithium bis(oxalato) borate. The electrolyte solution can form a cathode electrolyte interface (CEI) film and an anode electrolyte interface (SEI) film that contain diverse constituents and that are of a moderate thickness, enhance the stability of the cathode interface and the anode interface, and can function at both high and low temperatures, thereby improving the low-temperature cycling performance and high-temperature storage performance of the lithium-ion battery. In addition, the additive A and the additive B can jointly promote the migration of lithium ions, thereby reducing the impedance of the lithium-ion battery.

Definitely, a single product or method in which the technical solution of this application is implemented does not necessarily achieve all of the above advantages concurrently.

### DETAILED DESCRIPTION

The following clearly and fully describes the technical solutions in the embodiments of this application. Apparently, the described embodiments are merely a part of but not all of the embodiments of this application. All other embodiments derived by a person skilled in the art based on this application still fall within the protection scope of this application.

A first aspect of this application provides an electrolyte solution. The electrolyte solution includes an additive A and an additive B. The additive A includes at least one selected from a group consisting of a compound of Formula (I-1), a compound of Formula (I-2), or a compound of Formula (I-3):

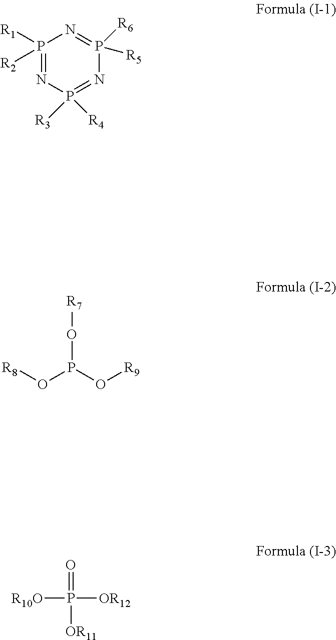

In the formulas above, R₁, R₂, R₃, R₄, R₅, and R₆ each are independently selected from a halogen atom, a C₁ to C₁₂ alkyl or a C₁ to C₁₂ alkoxyl; R₇, R₈, and R₉ each are independently selected from a hydrogen atom, a halogen atom, a silyl, a cyano group, an acyloxy, a sulfonyl, a C₁ to C₁₀ alkyl, a C₁ to C₁₀ haloalkyl, a C₂ to C₁₀ alkenyl, a C₂ to C₁₀ haloalkenyl, a C₂ to C₁₀ alkynyl, or a C₂ to C₁₀ haloalkynyl; and R₁₀, R₁₁, and R₁₂ each are independently selected from a hydrogen atom, a halogen atom, a C₁ to C₇ alkyl, a C₁ to C₇ haloalkyl, a C₂ to C₇ alkenyl, a C₂ to C₇ haloalkenyl, a C₂ to C₇ alkynyl, a C₂ to C₇ haloalkynyl, a C₆ to C₁₀ aryl, or a C₆ to C₁₀ haloaryl. The additive B includes at least one of lithium bis(trifluoromethanesulfonyl)imide, Lithium difluoro (bisoxalato)phosphate, or lithium bis(oxalato) borate. In this application, the number of silicon atoms in the silyl group is 1 to 4.

The electrolyte solution includes the above types of additive A and additive B. The synergistic effect of both additives can help to form a cathode electrolyte interface (CEI) film and an anode electrolyte interface (SEI) film that contain diverse constituents and that are of a moderate thickness, enhance the stability of the cathode interface and the anode interface, and can function at both high and low temperatures, thereby improving the low-temperature cycling performance and high-temperature storage performance of the lithium-ion battery. In addition, the additive A and the additive B can jointly promote the migration of lithium ions, thereby reducing the impedance of the lithium-ion battery. In this application, “high temperature” means a temperature higher than or equal to 40° C., and “low temperature” means a temperature lower than or equal to 0° C.

In some embodiments of this application, based on a mass of the electrolyte solution, a mass percentage of the additive A is W₁, and a mass percentage of the additive B is W₂, satisfying: 0.01≤W₁/W₂≤80, 0.01%≤W₁≤5%, and 0.01%≤W₂≤ 6%. Preferably, 0.01%≤W₁≤3%, and 0.01%≤W₂≤4%. For example, the W₁/W₂ ratio may be 0.01, 5, 20, 36, 40, 53, 60, 78, 80, or a value falling within a range formed by any two thereof; W₁ may be 0.01%, 1%, 1.8%, 2%, 3%, 3.6%, 4%, 4.8%, 5%, or a value falling within a range formed by any two thereof; and W₂ may be 0.01%, 1%, 1.2%, 2%, 2.6%, 3%, 3.5%, 4%, 4.7%, 5%, 6%, or a value falling within a range formed by any two thereof. By regulating the values of the W₁/W₂ ratio, W₁, and W₂ to fall within the above ranges, this application can exert the synergistic effect of the additive A and the additive B, help to form a CEI film and an SEI film that contain diverse constituents and that are of a moderate thickness, enhance the stability of the cathode interface and the anode interface, and promote migration of lithium ions, thereby reducing the impedance of the lithium-ion battery and improving the low-temperature cycling performance and high-temperature storage performance of the lithium-ion battery.

In some embodiments of this application, the compound of Formula (I-1) includes at least one of the following compounds:

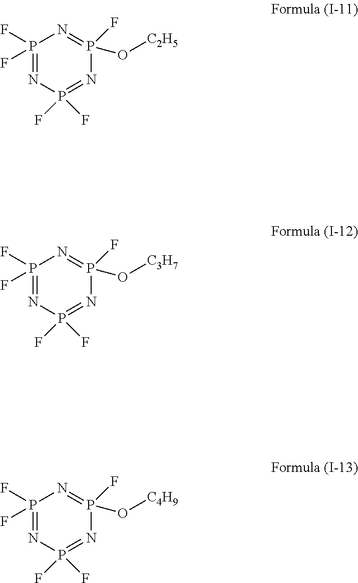

In some embodiments of this application, the compound of Formula (I-2) includes at least one of the following compounds:

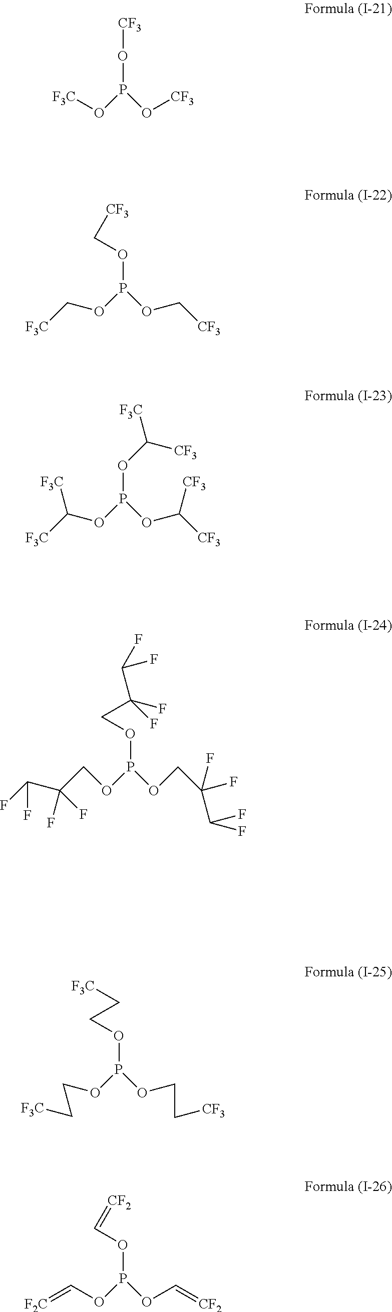

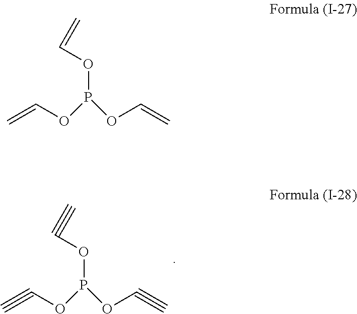

In some embodiments of this application, the compound of Formula (I-3) includes at least one of trimethyl phosphate, triethyl phosphate, triphenyl phosphate, tris(hexafluoroisopropyl) phosphate, tris(trifluoroethyl) phosphate, tris(2-trifluoromethylallyl)phosphate, tris(2-trifluoromethyl-but-3-ynyl)phosphate, or difluoroethyl trifluoroethyl hexafluoroisopropyl phosphate.

The electrolyte solution containing the additive A that falls within the above range can exert a stronger synergistic effect between the additive A and the additive B, help to form a CEI film and an SEI film that contain diverse constituents and that are of a moderate thickness, further enhance the stability of the cathode interface and the anode interface, and promote migration of lithium ions, thereby further reducing the impedance of the lithium-ion battery and improving the low-temperature cycling performance and high-temperature storage performance of the lithium-ion battery.

In some embodiments of this application, the additive A includes the compound of Formula (I-1). Based on the mass of the electrolyte solution, the mass percentage of the compound of Formula (I-1) is 0.01% to 3%. For example, the mass percentage of the compound of Formula (I-1) may be 0.01%, 0.8%, 1%, 1.6%, 2%, 2.5%, 3%, or a value falling within a range formed by any two thereof. Letting the additive A contain the compound of Formula (I-1) and regulating the mass percentage of the compound to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive A includes the compound of Formula (I-2). Based on the mass of the electrolyte solution, the mass percentage of the compound of Formula (I-2) is 0.01% to 2%. For example, the mass percentage of the compound of Formula (I-2) may be 0.01%, 0.4%, 0.8%, 1%, 1.2%, 1.4%, 1.6%, 2%, or a value falling within a range formed by any two thereof. Letting the additive B contain the compound of Formula (I-2) and regulating the mass percentage of the compound to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive A includes the compound of Formula (I-3). Based on the mass of the electrolyte solution, the mass percentage of the compound of Formula (I-3) is 0.01% to 3%. For example, the mass percentage of the compound of Formula (I-3) may be 0.01%, 0.4%, 1%, 1.5%, 2%, 2.6%, 3%, or a value falling within a range formed by any two thereof. Letting the additive A contain the compound of Formula (1-3) and regulating the mass percentage of the compound to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive A includes the compound of Formula (I-1) and the compound of Formula (I-2). Letting the electrolyte solution contain the above types of additive A can further alleviate the performance fluctuation of the lithium-ion battery at different temperatures and make the lithium-ion battery work in a broader operating temperature window, thereby favorably endowing the lithium-ion battery with good low-temperature cycling performance and high-temperature storage performance in addition to a relatively low impedance.

In some embodiments of this application, the additive A includes the compound of Formula (I-2) and the compound of Formula (I-3). Letting the electrolyte solution contain the above types of additive A can further alleviate the performance fluctuation of the lithium-ion battery at different temperatures and make the lithium-ion battery work in a broader operating temperature window, thereby favorably endowing the lithium-ion battery with good low-temperature cycling performance and high-temperature storage performance in addition to a relatively low impedance.

In some embodiments of this application, the additive B includes lithium bis(trifluoromethanesulfonyl)imide. Based on the mass of the electrolyte solution, the mass percentage of the lithium bis(trifluoromethanesulfonyl)imide is 0.01% to 4%, and preferably 0.01% to 3%. For example, the mass percentage of the lithium bis(trifluoromethanesulfonyl)imide may be 0.01%, 0.5%, 1%, 2%, 2.6%, 3%, 3.8%, 4%, or a value falling within a range formed by any two thereof. Letting the additive B contain the lithium bis(trifluoromethanesulfonyl)imide and regulating the mass percentage of the lithium bis(trifluoromethanesulfonyl)imide to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive B includes Lithium difluoro (bisoxalato)phosphate. Based on the mass of the electrolyte solution, the mass percentage of the Lithium difluoro (bisoxalato)phosphate is 0.01% to 6%. For example, the mass percentage of the Lithium difluoro (bisoxalato)phosphate is 0.01%, 0.6%, 1%, 2%, 2.4%, 3%, 4%, 4.8%, 5%, 5.4%, 6%, or a value falling within a range formed by any two thereof. Letting the additive B contain the Lithium difluoro (bisoxalato)phosphate and regulating the mass percentage of the Lithium difluoro (bisoxalato)phosphate to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive B includes lithium bis(oxalato) borate. Based on the mass of the electrolyte solution, the mass percentage of the lithium bis(oxalato) borate is 0.01% to 5%, and preferably 0.01% to 2.5%. For example, the mass percentage of the lithium bis(oxalato) borate may be 0.01%, 1%, 1.4%, 2%, 3%, 3.6%, 4%, 4.4%, 5%, or a value falling within a range formed by any two thereof. Letting the additive B contain the lithium bis(oxalato) borate and regulating the mass percentage of the lithium bis(oxalato) borate to fall within the above range can further reduce the side reactions between the positive active material, the negative active material, and the electrolyte solution, and enhance the stability of the CEI film and the SEI film, thereby further reducing the impedance of the lithium-ion battery and improving the low-temperature cycling performance and high-temperature storage performance of the lithium-ion battery.

In some embodiments of this application, the additive B includes lithium bis(trifluoromethanesulfonyl)imide and Lithium difluoro (bisoxalato)phosphate. Letting the electrolyte solution contain the above types of additive B can further enhance the stability of the cathode electrolyte interface, thereby further reducing the impedance of the lithium-ion battery and improving the low-temperature cycling performance and high-temperature storage performance of the lithium-ion battery.

In some embodiments of this application, the additive B includes lithium bis(trifluoromethanesulfonyl)imide and lithium bis(oxalato) borate. Letting the electrolyte solution contain the above types of additive B can further enhance the stability of the cathode electrolyte interface, thereby further reducing the impedance of the lithium-ion battery and improving the low-temperature cycling performance and high-temperature storage performance of the lithium-ion battery.

In some embodiments of this application, the additive B includes Lithium difluoro (bisoxalato)phosphate and lithium bis(oxalato) borate. Letting the electrolyte solution contain the above types of additive B can further enhance the stability of the cathode electrolyte interface, thereby further reducing the impedance of the lithium-ion battery and improving the low-temperature cycling performance and high-temperature storage performance of the lithium-ion battery.

In some embodiments of this application, the additive B includes lithium bis(trifluoromethanesulfonyl)imide, Lithium difluoro (bisoxalato)phosphate, and lithium bis(oxalato) borate. Letting the electrolyte solution contain the above types of additive B can further enhance the stability of the cathode electrolyte interface, thereby further reducing the impedance of the lithium-ion battery and improving the low-temperature cycling performance and high-temperature storage performance of the lithium-ion battery.

In this application, the electrolyte solution further includes a lithium salt. Based on the mass of the electrolyte solution, the mass percentage of the lithium salt is 8% to 15%. By regulating the mass percentage of the lithium salt to fall within the above range, the electrolyte solution can achieve a relatively low viscosity and a relatively high conductivity, thereby facilitating migration of ions in the electrolyte solution, and in turn, reducing the impedance of the lithium-ion battery and improving the low-temperature cycling performance and high-temperature storage performance of the lithium-ion battery. In some embodiments of this application, the lithium salt includes at least one of LiPF₆, LiSbF₆, LiAsF₆, LiClO₄, LIN(C₂F₅SO₂)₂, LIN(CF₃SO₂)₂, CF₃SO₃Li, LiC(CF₃SO₂)₃, or LiC₄BO₈.

In this application, the electrolyte solution further includes a nonaqueous solvent. Based on the mass of the electrolyte solution, the mass percentage of the nonaqueous solvent is 74% to 90%. The type of the nonaqueous solvent is not particularly limited herein, as long as the objectives of this application can be achieved. For example, the nonaqueous solvent may include, but is not limited to, at least one of a carbonate compound, a carboxylate compound, or an ether compound. The carbonate compound may include, but is not limited to, at least one of a chain carbonate compound, a cyclic carbonate compound, or a fluorocarbonate compound. The chain carbonate compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate compound may include, but is not limited to, at least one of ethylene carbonate (EC), propylene carbonate (PC), butylene carbonate (BC), or vinyl ethylene carbonate (VEC). The fluorocarbonate compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, mevalonolactone, or caprolactone. The ether compound may include, but is not limited to, at least one of dibutyl ether, tetraglyme, diglyme, 1,2-dimethoxyethane, 1,2-diethoxyethane, ethoxymethoxyethane, 2-methyltetrahydrofuran, or tetrahydrofuran.

A second aspect of this application provides a lithium-ion battery. The lithium-ion battery includes a positive electrode plate, a negative electrode plate, and an electrolyte solution. The electrolyte solution is the electrolyte solution disclosed in the first aspect of this application. The positive electrode plate includes a positive active material layer. The positive active material layer includes a positive active material. The positive active material includes lithium nickel cobalt manganese oxide. A specific surface area of the lithium nickel cobalt manganese oxide is 0.1 m²/g to 2.0 m²/g, and preferably 0.1 m²/g to 1.8 m²/g. For example, the specific surface area of the lithium nickel cobalt manganese oxide may be 0.1 m²/g, 0.4 m²/g, 0.8 m²/g, 1.2 m²/g, 1.6 m²/g, 1.8 m²/g, 2.0 m²/g, or a value falling within a range formed by any two thereof. By regulating the specific surface area of the lithium nickel cobalt manganese oxide as a positive active material to fall within the above range, the positive active material is not prone to react parasitically with the electrolyte solution. In addition, the mass percentage of the additive A and/or additive B in the electrolyte solution may be further regulated to optimize the structure of the cathode electrolyte interface film, thereby further reducing the impedance of the lithium-ion battery and improving the low-temperature cycling performance and high-temperature storage performance of the lithium-ion battery.

In some embodiments of this application, the chemical formula of lithium nickel cobalt manganese oxide may be LiNi_{0.8}Co_{0.1}Mn_{0.1}O₂ (NCM811), but is not limited to LiNi_{0.8}Co_{0.1}Mn_{0.1}O₂ (NCM811).

The method for regulating the specific surface area of the lithium nickel cobalt manganese oxide is not particularly limited herein, as long as the objectives of this application can be achieved. For example, the lithium nickel cobalt manganese oxide with different specific surface areas may be obtained by mechanical crushing, grinding, sieving, and the like. As an example, the lithium nickel cobalt manganese oxide with different specific surface areas may be obtained by ball-milling as a means of mechanical crushing. Generally, the specific surface area is increased by increasing the ball-milling time, and the specific surface area is decreased by shortening the ball-milling time.

The positive electrode plate of this application may further include a positive current collector. The positive current collector is not particularly limited herein, as long as the objectives of this application can be achieved. For example, the positive current collector may be, but is not limited to, an aluminum foil, an aluminum alloy foil, a composite current collector (such as an aluminum carbon composite current collector). The thicknesses of the positive current collector and positive active material layer are not particularly limited herein, as long as the objectives of this application can be achieved. For example, the thickness of the positive current collector is 6 μm to 12 μm, and the thickness of the positive active material layer is 30 μm to 120 μm. The thickness of the positive electrode plate is not particularly limited herein, as long as the objectives of this application can be achieved. For example, the thickness of the positive electrode plate is 50 μm to 250 μm. In this application, the positive active material layer may be disposed on one surface of the positive current collector in a thickness direction of the current collector or on both surfaces of the positive current collector in the thickness direction. It is hereby noted that the “surface” here may be the entire region of the positive current collector, or a partial region of the positive current collector, without being particularly limited herein, as long as the objectives of the application can be achieved.

The positive active material layer may further include a positive conductive agent and a positive electrode binder. The types of the positive conductive agent and the positive electrode binder are not particularly limited herein, as long as the objectives of this application can be achieved. For example, the positive electrode binder may include, but is not limited to, at least one of polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, styrene-butadiene rubber, acrylated (acrylate-esterified) styrene-butadiene rubber, epoxy resin, or nylon. The positive conductive agent may include, but is not limited to, at least one of a carbon-based material, a metal-based material, or a conductive polymer. As an example, the carbon-based material may include at least one of natural graphite, artificial graphite, conductive carbon black (Super P), or carbon fiber. The metal-based material may include, but is not limited to, at least one of metal powder, metal fibers, copper, nickel, aluminum, or silver. The conductive polymer may include, but is not limited to, a polyphenylene derivative. The mass ratio between the positive active material, the positive conductive agent, and the positive binder in the positive active material layer is not particularly limited herein, and may be selected as actually required, as long as the objectives of this application can be achieved.

In this application, the negative electrode plate is not particularly limited, as long as the objectives of this application can be achieved. For example, the negative electrode plate includes a negative current collector and a negative active material layer disposed on at least one surface of the negative current collector. In this application, the negative active material layer may be disposed on one surface of the negative current collector in the thickness direction or on both surfaces of the negative current collector in the thickness direction. It is hereby noted that the “surface” here may be the entire region of the negative current collector, or a partial region of the negative current collector, without being particularly limited herein, as long as the objectives of the application can be achieved.

The negative current collector is not particularly limited herein, as long as the objectives of this application can be achieved. For example, the negative current collector may be, but is not limited to, a copper foil, a copper alloy foil, a nickel foil, a stainless steel foil, a titanium foil, foamed nickel, foamed copper, a composite current collector (such as a carbon copper composite current collector, a nickel copper composite current collector, or a titanium copper composite current collector), or the like. In this application, the thicknesses of the negative current collector and the negative active material layer are not particularly limited, as long as the objectives of this application can be achieved. For example, the thickness of the negative current collector is 6 μm to 12 μm, and the thickness of the negative active material layer is 30 μm to 130 μm. The thickness of the negative electrode plate is not particularly limited in this application, as long as the objectives of this application can be achieved. For example, the thickness of the negative electrode plate is 50 μm to 280 μm.

The negative active material layer of this application includes a negative active material. The negative active material may include, but is not limited to, at least one of graphite, mesocarbon microbeads (MCMB), hard carbon, soft carbon, silicon, a silicon-carbon composite, SiOₓ (0.5<x<1.6), a Li—Sn alloy, a Li—Sn—O alloy, Sn, SnO, SnO₂, spinel-structured lithium titanium oxide lithiated TiO₂—Li₄Ti₅O₁₂, a Li—Al alloy, or metallic lithium.

The negative active material layer in this application may further include a negative electrode binder and a negative conductive agent, or, the negative active material layer may further include a negative electrode binder, a negative conductive agent, and a thickener. The types of the negative electrode binder and the negative conductive agent are not particularly limited herein, as long as the objectives of this application can be achieved. For example, the negative electrode binder may include, but is not limited to, at least one of the above-mentioned positive electrode binders, and the negative conductive agent may include, but is not limited to, at least one of the above-mentioned positive conductive agents. The type of thickener is not particularly limited herein, as long as the objectives of this application can be achieved. For example, the thickener may include, but is not limited to, at least one of sodium carboxymethyl cellulose or carboxymethyl cellulose.

The separator is not particularly limited herein, as long as the objectives of this application can be achieved. For example, the separator may be made of a material including but not limited to at least one of: a polyethylene (PE)- or polypropylene (PP)-based polyolefin (PO), a polyester (such as polyethylene terephthalate (PET) film), cellulose, polyimide (PI), polyamide film (PA), spandex, or aramid. The type of the separator may include at least one of a woven film, a non-woven film, a microporous film, a composite film, a laminated film, or a spinning film. For example, the separator may include a substrate layer and a surface treatment layer. The substrate layer may be a non-woven fabric, film or composite film, which, in each case, is porous. The material of the substrate layer may include at least one of polyethylene, polypropylene, polyethylene terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is disposed on at least one surface of the substrate layer. The surface treatment layer may be a polymer layer or an inorganic compound layer, or a layer compounded of a polymer and an inorganic compound. For example, the inorganic compound layer includes inorganic particles and a binder. The inorganic particles are not particularly limited herein, and may include, for example, at least one of aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited herein, and may be, for example, at least one of the above-mentioned positive electrode binders. The polymer layer includes a polymer. The polymer is not particularly limited herein. For example, the polymer includes at least one of polyamide, polyacrylonitrile, acrylate polymer, polyacrylic acid, polyacrylate, polyvinylpyrrolidone, polyvinyl ether, polyvinylidene difluoride, or poly(vinylidene difluoride-co-hexafluoropropylene). The thickness of the separator is not particularly limited in this application, as long as the objectives of this application can be achieved. For example, the thickness of the separator may be 5 μm to 500 μm.

The lithium-ion battery of this application further includes a packaging bag. The packaging bag is configured to accommodate a positive electrode plate, a separator, a negative electrode plate, an electrolyte solution, and other components known in the art for use in the lithium-ion battery. Such other components are not particularly limited herein. The packaging bag is not particularly limited herein, and may be a packaging bag well-known in the art, as long as the objectives of this application can be achieved. For example, the pocket may be an aluminum laminated film.

The process of preparing the lithium-ion battery in this application is well known to a person skilled in the art, and is not particularly limited herein. For example, the preparation process may include, but is not limited to, the following steps: stacking the positive electrode plate, the separator, and the negative electrode plate in sequence, and performing operations such as winding and folding as required to obtain a jelly-roll electrode assembly; putting the electrode assembly into a package, injecting the electrolyte solution into the package, and sealing the package to obtain a lithium-ion battery; or, stacking the positive electrode plate, the separator, and the negative electrode plate in sequence, and then fixing the four corners of the entire stacked structure by use of adhesive tape to obtain a stacked-type electrode assembly, putting the electrode assembly into a package, injecting the electrolyte solution into the package, and sealing the package to obtain a lithium-ion battery. In addition, an overcurrent prevention component, a guide plate, and the like may be placed into the packaging bag as required, so as to prevent the rise of internal pressure, overcharge, and overdischarge of the lithium-ion battery.

A third aspect of this application provides an electronic device. The electronic device includes the lithium-ion battery disclosed in the second aspect of this application. The lithium-ion battery disclosed in this application incurs a relatively low impedance and achieves good low-temperature cycling performance and high-temperature storage performance, so that the electronic device disclosed in this application achieves a relatively long lifespan and good performance.

The electronic device is not particularly limited herein, and may be any electronic device known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Test Methods and Devices

### Measuring the Specific Surface Area:

Measuring the specific surface area of the positive active material in each embodiment and each comparative embodiment by a nitrogen adsorption method by using a specific surface area analyzer (Tristar II 3020M) Specifically, the measurement is performed with reference to the national standard GB/T19587-2017 Determination of the Specific Surface Area of Solids by Gas Adsorption Using the BET Method.

### Testing the Low-Temperature Cycling Performance:

Putting a lithium-ion battery into a −10° C. thermostat, and leaving the battery to stand for 30 minutes so that the lithium-ion battery reaches a constant-temperature state. Charging, after the lithium-ion battery reaches a constant-temperature state, the lithium-ion battery at a constant current of 0.2C at −10° C. until the voltage reaches 4.3 V, and then charging the battery at constant voltage of 4.3 V until the current drops to 0.05C; leaving the battery to stand for 5 minutes, and then discharging the battery at a constant current of 0.2C until the voltage drops to 3.0V, and then leaving the battery to stand for 5 minutes, measuring the discharge capacity of the battery, and recording the measured value as an initial capacity C₁₁; subsequently, charging the battery at a constant current of 0.5C until the voltage reaches 4.2 V, and then charging the battery at a constant voltage of 4.2 V until the current drops to 0.3C; afterward, charging the battery at a constant current of 0.3C until the voltage reaches 4.3 V, and then charging the battery at a constant voltage of 4.3 V until the current drops to 0.05C, and leaving the battery to stand for 5 minutes; next, discharging the battery at a constant current of 0.2C until the voltage drops to 3.0 V, and then leaving the battery to stand for 5 minutes, thereby completing one charge-discharge cycle. Repeating the above charge-discharge cycle, and measuring the discharge capacity of the lithium-ion battery at the end of 200 cycles, denoted as C₁₂.

Using the following formula to calculate the capacity retention rate of the battery cycled at −10° C.:

$$Capacity retention rate after cycling at - 10 ° C . = {C}_{12} / {C}_{11} \times 100 \% .$$

### Testing the High-Temperature Storage Performance:

Putting a lithium-ion battery into a 25° C. thermostat, and leaving the battery to stand for 30 minutes so that the lithium-ion battery reaches a constant-temperature state. Charging, after the lithium-ion battery reaches a constant-temperature state, the lithium-ion battery at a constant current of 0.7C until the voltage reaches 4.3 V, and then charging the battery at constant voltage of 4.3 V until the current reaches 82.5 mA. Measuring the thickness of the lithium-ion battery, denoted as T₀. Storing the battery in an 85° C. oven for 8 hours, and then taking the battery out of the oven, cooling the battery for 1 hour, and measuring the thickness of the lithium-ion battery, denoted as T₁. Monitoring the thickness of the lithium-ion battery in the oven in real time.

Using the following formula to calculate the thickness expansion rate after storage at 85° C.:

$$Thickness expansion rate after storage at 85 ° C . = ( {T}_{1} - {T}_{0} ) / {T}_{0} \times 100 \% .$$

### Testing the Direct-Current Resistance (DCR) Change Rate:

Charging a lithium-ion battery at 25° C. at a constant current of 0.7C until the voltage reaches 4.3 V, and then charging the battery at a constant voltage of 4.3 V until the current reaches 82.5 mA, and then discharging the lithium-ion battery at a constant current of 0.2C for 4 hours so that the state of charge (SOC) of the lithium-ion battery is 20%. Discharging the battery at a current of 0.1C for 10 seconds, and measuring the voltage, denoted as V₀, and then discharging the battery at a current of 1C for 1 second, and measuring the voltage, denoted as V₁. DCR cycled at 25° C. in the initial state=(V₀−V₁)/0.1C.

Putting a lithium-ion battery into a 25° C. thermostat, and leaving the battery to stand for 30 minutes so that the lithium-ion battery reaches a constant-temperature state. Charging the constant-temperature lithium-ion battery at 25° C. at a constant current of 0.7C until the voltage reaches 4.3 V, and then charging the battery at a constant voltage of 4.3 V until the current reaches 82.5 mA. Subsequently, discharging the battery at a constant current of 0.2C until the voltage reaches 3.0 V, thereby completing one charge-discharge cycle. Repeating the above charging and discharging steps for 1000 cycles, and then charging the battery at a constant current of 0.7C until the voltage reaches 4.3 V, and then charging the battery at a constant voltage of 4.3 V until the current reaches 82.5 mA. Subsequently, discharging the battery at a constant current of 0.2C for 4 hours so that the state of charge (SOC) of the lithium-ion battery is 20%. Discharging the battery at a current of 0.1C for 10 seconds, and measuring the voltage, denoted as V₂, and then discharging the battery at a current of 1C for 1 second, and measuring the voltage, denoted as V₃. DCR cycled at 25° C. for 1000 cycles=(V₂−V₃)/0.1C.

Calculating the DCR change rate of the battery cycled at 25° C. by use of the following formula:

$$DCR change rate of the battery cycled at 25 ° C . = ( DCR cycled at 25 ° C . for 1000 cycles ) / DCR cycled at 25 ° C . in the initial state - 1 ) \times 100 \% .$$

Charging a lithium-ion battery at 45° C. at a constant current of 0.7C until the voltage reaches 4.3 V, and then charging the battery at a constant voltage of 4.3 V until the current reaches 82.5 mA, and then discharging the lithium-ion battery at a constant current of 0.2C for 4 hours so that the state of charge (SOC) of the lithium-ion battery is 20%. Discharging the battery at a current of 0.1C for 10 seconds, and measuring the voltage, denoted as V₄, and then discharging the battery at a current of 1C for 1 second, and measuring the voltage, denoted as V₅. DCR cycled at 45° C. in the initial state=(V₄−V₅)/0.1C.

Putting a lithium-ion battery into a 45° C. thermostat, and leaving the battery to stand for 30 minutes so that the lithium-ion battery reaches a constant-temperature state. Charging the constant-temperature lithium-ion battery at 45° C. at a constant current of 0.7C until the voltage reaches 4.3 V, and then charging the battery at a constant voltage of 4.3 V until the current reaches 82.5 mA. Subsequently, discharging the battery at a constant current of 0.2C until the voltage reaches 3.0 V, thereby completing one charge-discharge cycle. Repeating the above charging and discharging steps for 700 cycles, and then charging the battery at a constant current of 0.7C until the voltage reaches 4.3 V, and then charging the battery at a constant voltage of 4.3 V until the current reaches 82.5 mA. Subsequently, discharging the battery at a constant current of 0.2C for 4 hours so that the state of charge (SOC) of the lithium-ion battery is 20%. Discharging the battery at a current of 0.1C for 10 seconds, and measuring the voltage, denoted as V₆, and then discharging the battery at a current of 1C for 1 second, and measuring the voltage, denoted as V₇. DCR cycled at 45° C. for 700 cycles=(V₆−V₇)/0.1C.

Calculating the DCR change rate of the battery cycled at 45° C. by use of the following formula:

$$DCR change rate of battery cycled at 45 ° C . = ( DCR cycled at 45 ° C . for 700 cycles ) / DCR cycled at 45 ° C . in the initial state - 1 ) \times 100 \% .$$

### Embodiment 1-1

### <Preparing an Electrolyte Solution>

Mixing ethylene carbonate (EC), propylene carbonate (PC), and diethyl carbonate (DEC) at a mass ratio of 1:1:1 in an environment in which the water content is less than 10 ppm, so as to prepare a nonaqueous base solvent; and then adding a lithium salt LiPF₆ into the base solvent to dissolve, and stirring well to obtain a base solution. Adding the compound of Formula (I-11) as additive A and lithium bis(trifluoromethanesulfonyl)imide as additive B into the base solution, and stirring well to obtain an electrolyte solution. Based on the mass of the electrolyte solution, the mass percentage of LiPF₆ is 12.5%, the mass percentage of the compound of Formula (I-11), denoted as W₁, is 0.01%, and the mass percentage of the lithium bis(trifluoromethanesulfonyl)imide, denoted as W₂, is 1%, and the remainder is the base solvent.

### <Preparing a Positive Electrode Plate>

Mixing lithium nickel cobalt manganese oxide LiNi_{0.8}Co_{0.1}Mn_{0.1}O₂ (NCM811), conductive carbon black as a positive conductive agent, polyvinylidene difluoride (PVDF) as a positive electrode binder at a mass ratio of 96.6:1.5:1.9, adding N-methyl-pyrrolidone (NMP), and stirring well with a vacuum mixer to obtain a positive electrode slurry in which the solid content is 75 wt %. Coating one surface of a 10 μm-thick positive current collector aluminum foil with the positive electrode slurry evenly, and drying the aluminum foil at 120° C. to obtain a positive electrode plate coated with an 80 μm-thick positive active material layer on a single side. Repeating the foregoing steps on the other surface of the aluminum foil to obtain a positive electrode plate coated with the positive active material layer on both sides. Subsequently, performing cold-calendaring, cutting, slitting, and tab welding, and performing drying in a 120° C. vacuum environment for 3 hours to obtain a positive electrode plate. The specific surface area of the lithium nickel cobalt manganese oxide as a positive active material is BET=1 m²/g.

### <Preparing a Negative Electrode Plate>

Mixing artificial graphite as a negative active material, Super P as a negative conductive agent, sodium carboxymethyl cellulose (CMC) as a thickener, and styrene-butadiene rubber (SBR) as a negative electrode binder at a mass ratio of 96.4:1.5:0.5:1.6. Adding deionized water, and mixing well with a vacuum mixer to obtain a negative electrode slurry in which the solid content is 54 wt %. Coating one surface of a 10-μm thick negative current collector copper foil with the negative electrode slurry evenly, and drying the copper foil at 85° C. to obtain a negative electrode plate coated with a 70 μm-thick negative active material layer on a single side. Repeating the foregoing steps on the other surface of the aluminum foil to obtain a negative electrode plate coated with the negative active material layer on both sides. Subsequently, performing cold-calendaring, cutting, slitting, and tab welding, and performing drying in a 120° C. vacuum environment for 12 hours to obtain a negative electrode plate.

### <Preparing a Separator>

Using a 5 μm-thick polyethylene (PE) porous film (manufactured by Celgard) as a separator.

### <Preparing a Lithium-Ion Battery>

Stacking the above-prepared negative electrode plate, separator, and positive electrode plate sequentially, and winding the stacked structure to obtain a jelly-roll electrode assembly. Putting the electrode assembly into an aluminum laminated film pocket, drying the pocket, and then injecting the electrolyte solution. Performing steps such as vacuum sealing, static standing, chemical formation (charging the battery at a constant current of 0.02C until the voltage reaches 3.5 V, and then charging the battery at a constant current of 0.1C until the voltage reaches 3.9 V), capacity grading, degassing, and edge trimming to obtain a lithium-ion battery.

### Embodiments 1-2 to 1-26

Identical to Embodiment 1-1 except that the relevant preparation parameters are adjusted according to Table 1. When the mass percentage of the additive A and/or the additive B changes, the mass percentage of the base solvent changes accordingly, and the mass ratio between the EC, the PC, and the DEC, and the mass percentage of the lithium salt remain unchanged.

### Embodiments 2-1 to 2-3

Identical to Embodiment 1-2 except that, in <Preparing a positive electrode plate>, the specific surface area of lithium nickel cobalt manganese oxide as a positive active material complies with Table 2 by regulating the ball-milling time.

### Comparative Embodiment 1-1

Identical to Embodiment 1-1 except the process of <Preparing an electrolyte solution>.

### <Preparing an Electrolyte Solution>

Mixing ethylene carbonate (EC), propylene carbonate (PC), and diethyl carbonate (DEC) at a mass ratio of 1:1:1 in an environment in which the water content is less than 10 ppm, so as to prepare a nonaqueous base solvent; and then adding a lithium salt LiPF₆ into the base solvent to dissolve, and stirring well to obtain a base solution. Adding lithium bis(trifluoromethanesulfonyl)imide as additive B into the base solution, and stirring well to obtain an electrolyte solution. Based on the mass of the electrolyte solution, the mass percentage of LiPF₆ is 12.5%, and the mass percentage of the lithium bis(trifluoromethanesulfonyl)imide, denoted as W₂, is 3%.

### Comparative Embodiment 1-2

Identical to Embodiment 1-1 except the process of <Preparing an electrolyte solution>.

### <Preparing an Electrolyte Solution>

Mixing ethylene carbonate (EC), propylene carbonate (PC), and diethyl carbonate (DEC) at a mass ratio of 1:1:1 in an environment in which the water content is less than 10 ppm, so as to prepare a nonaqueous base solvent; and then adding a lithium salt LiPF₆ into the base solvent to dissolve, and stirring well to obtain a base solution. Adding the compound of Formula (I-11) as additive A into the base solution, and stirring well to obtain an electrolyte solution. Based on the mass of the electrolyte solution, the mass percentage of LiPF₆ is 12.5%, and the mass percentage of the compound of Formula (I-11), denoted as W₁, is 1.5%.

### Comparative Embodiment 1-3

Identical to Embodiment 1-1 except the process of <Preparing an electrolyte solution>.

### <Preparing an Electrolyte Solution>

Mixing ethylene carbonate (EC), propylene carbonate (PC), and diethyl carbonate (DEC) at a mass ratio of 1:1:1 in an environment in which the water content is less than 10 ppm, so as to prepare a nonaqueous base solvent; and then adding a lithium salt LiPF₆ into the base solvent to dissolve, and stirring well to obtain a base solution. Based on the mass of the electrolyte solution, the mass percentage of the LiPF₆ is 12.5%.

Table 1 to Table 2 show the preparation parameters and performance parameters of each embodiment and each comparative embodiment.

TABLE 1

| | | W₁ | | W₂ |
|---|---|---|---|---|
| | Type of additive A | (%) | Type of additive B | (%) |
| Embodiment 1-1 | Formula (I-11) | 0.01 | Lithium | 1 |
| | | | bis(trifluoromethanesulfonyl)imide | |
| Embodiment 1-2 | Formula (I-11) | 1.8 | Lithium | 3 |
| | | | bis(trifluoromethanesulfonyl)imide | |
| Embodiment 1-3 | Formula (I-11) | 2.7 | Lithium | 2.7 |
| | | | bis(trifluoromethanesulfonyl)imide | |
| Embodiment 1-4 | Formula (I-13) | 2.7 | Lithium | 3 |
| | | | bis(trifluoromethanesulfonyl)imide | |
| Embodiment 1-5 | Formula (I-21) | 0.01 | Lithium | 1 |
| | | | bis(trifluoromethanesulfonyl)imide | |
| Embodiment 1-6 | Formula (I-21) | 2 | Lithium | 3 |
| | | | bis(trifluoromethanesulfonyl)imide | |
| Embodiment 1-7 | Formula (I-21) | 0.4 | Lithium | 0.3 |
| | | | bis(trifluoromethanesulfonyl)imide | |
| Embodiment 1-8 | Triethyl phosphate | 0.01 | Lithium | 1 |
| | | | bis(trifluoromethanesulfonyl)imide | |
| Embodiment 1-9 | Triethyl phosphate | 1.5 | Lithium | 3 |
| | | | bis(trifluoromethanesulfonyl)imide | |
| Embodiment 1- | Triethyl phosphate | 2.8 | Lithium | 0.04 |
| 10 | | | bis(trifluoromethanesulfonyl)imide | |
| Embodiment 1- | Tris(hexafluoroisopropyl)phosphate | 1.5 | Lithium | 3 |
| 11 | | | bis(trifluoromethanesulfonyl)imide | |
| Embodiment 1- | Difluoroethyl trifluoroethyl | 1.5 | Lithium | 3 |
| 12 | hexafluoroisopropyl phosphate | | bis(trifluoromethanesulfonyl)imide | |
| Embodiment 1- | Formula (I-11) (1.5%) + Formula | 2.5 | Lithium | 0.05 |
| 13 | (I-21) (1%) | | bis(trifluoromethanesulfonyl)imide | |
| Embodiment 1- | Formula (I-21) (0.2%) + triethyl | 0.35 | Lithium | 0.3 |
| 14 | phosphate (0.15%) | | difluoro(bisoxalato)phosphate | |
| Embodiment 1- | Formula (I-11) (0.15%) + Formula | 0.5 | Lithium | 0.3 |
| 15 | (I-21) (0.2%) + triethyl phosphate | | bis(trifluoromethanesulfonyl)imide | |
| | (0.15%) | | | |
| Embodiment 1- | Formula (I-11) | 0.6 | Lithium | 0.3 |
| 16 | | | bis(trifluoromethanesulfonyl)imide | |
| Embodiment 1- | Formula (I-11) | 0.8 | Lithium | 0.16 |
| 17 | | | bis(trifluoromethanesulfonyl)imide | |
| Embodiment 1- | Formula (I-11) | 0.8 | Lithium | 0.08 |
| 18 | | | difluoro(bisoxalato)phosphate | |
| Embodiment 1- | Formula (I-11) | 1.5 | Lithium | 3 |
| 19 | | | difluoro(bisoxalato)phosphate | |
| Embodiment 1- | Formula (I-11) | 0.8 | Lithium bis(oxalato)borate | 0.01 |
| 20 | | | | |
| Embodiment 1- | Formula (I-11) | 1.5 | Lithium bis(oxalato)borate | 2.5 |
| 21 | | | | |
| Embodiment 1- | Formula (I-11) | 1.5 | Lithium | 4 |
| 22 | | | bis(trifluoromethanesulfonyl)imide | |
| | | | (2%) + Lithium | |
| | | | difluoro(bisoxalato)phosphate (2%) | |
| Embodiment 1- | Formula (I-11) | 0.4 | Lithium | 0.4 |
| 23 | | | difluoro(bisoxalato)phosphate | |
| | | | (0.2%) + lithium bis(oxalato)borate | |
| | | | (0.2%) | |
| Embodiment 1- | Formula (I-11) | 0.6 | Lithium | 0.6 |
| 24 | | | bis(trifluoromethanesulfonyl)imide | |
| | | | (0.2%) + Lithium | |
| | | | difluoro(bisoxalato)phosphate | |
| | | | (0.2%) + lithium bis(oxalato)borate | |
| | | | (0.2%) | |
| Embodiment 1- | Formula (I-11) | 0.8 | Lithium | 0.04 |
| 25 | | | bis(trifluoromethanesulfonyl)imide | |
| Embodiment 1- | Formula (I-11) | 0.9 | Lithium | 0.03 |
| 26 | | | bis(trifluoromethanesulfonyl)imide | |
| Comparative | \ | \ | Lithium | \ |
| Embodiment 1-1 | | | bis(trifluoromethanesulfonyl)imide | |
| Comparative | Formula (I-11) | 1.5 | \ | \ |
| Embodiment 1-2 | | | | |
| Comparative | \ | \ | \ | \ |
| Embodiment 1-3 | | | | |

| | | Capacity | Thickness | | |
|---|---|---|---|---|---|
| | | retention | expansion | DCR change | DCR change |
| | | rate after | rate after | rate when | rate when |
| | | cycling | storage at | cycled at | cycled at |
| | W₁/W₂ | at −10° C. (%) | 85° C. (%) | 25° C. (%) | 45° C. (%) |
| Embodiment 1-1 | 0.01 | 77.5 | 25.4 | 34.6 | 32.7 |
| Embodiment 1-2 | 0.6 | 78.3 | 24.6 | 33.2 | 31.5 |
| Embodiment 1-3 | 1 | 79.6 | 23.3 | 32.6 | 30.2 |
| Embodiment 1-4 | 0.9 | 80.9 | 22.5 | 31.8 | 29.7 |
| Embodiment 1-5 | 0.01 | 77.2 | 25.7 | 34.5 | 32.6 |
| Embodiment 1-6 | 0.667 | 79.8 | 23.2 | 32.4 | 30.1 |
| Embodiment 1-7 | 1.333 | 81.5 | 21.2 | 30.4 | 28.3 |
| Embodiment 1-8 | 0.01 | 77.3 | 25.5 | 34.8 | 32.9 |
| Embodiment 1-9 | 0.5 | 78.4 | 24.2 | 33.4 | 31.2 |
| Embodiment 1-10 | 70 | 78.7 | 23.8 | 33.2 | 29.9 |
| Embodiment 1-11 | 0.5 | 78.1 | 24.3 | 33.5 | 31.6 |
| Embodiment 1-12 | 0.5 | 78.4 | 24.2 | 33.7 | 31.4 |
| Embodiment 1-13 | 50 | 82.7 | 21.6 | 29.1 | 27.5 |
| Embodiment 1-14 | 1.167 | 82.4 | 21.9 | 29.3 | 27.8 |
| Embodiment 1-15 | 1.667 | 82.9 | 20.1 | 28.7 | 26.5 |
| Embodiment 1-16 | 2 | 82.3 | 20.6 | 28.9 | 26.7 |
| Embodiment 1-17 | 5 | 85.8 | 16.1 | 26.2 | 25.1 |
| Embodiment 1-18 | 10 | 85.5 | 16.6 | 26.7 | 25.9 |
| Embodiment 1-19 | 0.5 | 78.5 | 24.3 | 33.5 | 31.2 |
| Embodiment 1-20 | 80 | 76.5 | 26.2 | 35.3 | 33.2 |
| Embodiment 1-21 | 0.6 | 78.1 | 24.8 | 33.6 | 31.9 |
| Embodiment 1-22 | 0.375 | 78.9 | 24.3 | 33.1 | 30.8 |
| Embodiment 1-23 | 1 | 83.7 | 18.6 | 26.8 | 25.4 |
| Embodiment 1-24 | 1 | 84.5 | 18.2 | 26.1 | 24.9 |
| Embodiment 1-25 | 20 | 85.3 | 17.3 | 28.4 | 27.5 |
| Embodiment 1-26 | 30 | 85.1 | 17.7 | 28.9 | 27.8 |
| Comparative | 0 | 69.4 | 34.1 | 44.8 | 42.3 |
| Embodiment 1-1 | | | | | |
| Comparative | \ | 68.9 | 34.2 | 44.6 | 42.5 |
| Embodiment 1-2 | | | | | |
| Comparative | \ | 68.5 | 33.7 | 45.2 | 42.9 |
| Embodiment 1-3 | | | | | |

Note:
Using the data in Embodiment 1-13 in Table 1 as an example, “Formula (I-11) (1.5%) + Formula (I-21) (1%)” means that, based on the mass of the electrolyte solution, the mass percentage of the compound of Formula (I-11) is 1.5%, and the mass percentage of the compound of Formula (I-21) is 1%. Other embodiments are understood similarly. “\” in Table 1 indicates absence of the corresponding parameter.

As can be seen from Embodiments 1-1 to 1-26 and Comparative Embodiments 1-1 to 1-3, when the electrolyte solution containing the additive A and the additive B falling within the ranges specified herein is applied to a lithium-ion battery, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves better low-temperature cycling performance and high-temperature storage performance. In contrast, in the lithium-ion battery of Comparative Embodiment 1-1, the electrolyte solution contains no additive A; in the lithium-ion battery of Comparative Embodiment 1-2, the electrolyte solution contains no additive B; in the lithium-ion battery of Comparative Embodiment 1-3, the electrolyte solution contains neither additive A nor additive B. For the lithium-ion batteries of Comparative Embodiments 1-1 to 1-3, the capacity retention rate after cycling at −10° C. is lower, and the thickness expansion rate after storage at 85° C., the DCR change rate when cycled at 25° C., and the DCR change rate when cycled at 45° C. are higher, indicating that the lithium-ion battery incurs a higher impedance and worse low-temperature cycling performance and high-temperature storage performance.

As can be seen from Embodiments 1-1 to 1-16, the type of the additive A affects the impedance, the low-temperature cycling performance, and the high-temperature storage performance of the lithium-ion battery. When the electrolyte solution of the lithium-ion battery contains the additive A falling within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves good low-temperature cycling performance and high-temperature storage performance.

As can be seen from Embodiment 1-1 and Embodiments 1-17 to 1-26, the type of the additive B affects the impedance, the low-temperature cycling performance, and the high-temperature storage performance of the lithium-ion battery. When the electrolyte solution of the lithium-ion battery contains the additive B falling within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves good low-temperature cycling performance and high-temperature storage performance. As can be seen from Embodiments 1-1 to 1-16, the mass percentage of the additive A, denoted as W₁, affects the impedance, the low-temperature cycling performance, and the high-temperature storage performance of the lithium-ion battery. When the mass percentage of the additive A, denoted as W₁, in the electrolyte solution of the lithium-ion battery falls within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves good low-temperature cycling performance and high-temperature storage performance.

As can be seen from Embodiment 1-1 and Embodiments 1-17 to 1-26, the mass percentage of the additive B, denoted as W₂, affects the impedance, the low-temperature cycling performance, and the high-temperature storage performance of the lithium-ion battery. When the mass percentage of the additive B, denoted as W₂, in the electrolyte solution of the lithium-ion battery falls within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves good low-temperature cycling performance and high-temperature storage performance.

As can be seen from Embodiments 1-1 to 1-26, the W₁/W₂ ratio affects the impedance, the low-temperature cycling performance, and the high-temperature storage performance of the lithium-ion battery. When the W₁/W₂ ratio falls within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C. This indicates that the lithium-ion battery incurs a lower impedance and achieves good low-temperature cycling performance and high-temperature storage performance.

TABLE 2

| | Specific | | | | |
|---|---|---|---|---|---|
| | surface | | | | |
| | area of | Capacity | Thickness | DCR | DCR |
| | positive | retention | expansion | change | change |
| | active | rate after | rate after | rate when | rate when |
| | material | cycling | storage at | cycled at | cycled at |
| | (m²/g) | at −10° C. (%) | 85° C. (%) | 25° C. (%) | 45° C. (%) |
| Embodiment | 1 | 78.3 | 24.6 | 33.2 | 31.5 |
| 1-2 | | | | | |
| Embodiment | 0.1 | 78.1 | 24.8 | 33.7 | 31.8 |
| 2-1 | | | | | |
| Embodiment | 1.8 | 79.5 | 23.4 | 32.6 | 30.7 |
| 2-2 | | | | | |
| Embodiment | 2 | 79.3 | 23.5 | 32.9 | 32.2 |
| 2-3 | | | | | |

As can be seen from Embodiment 1-2 and Embodiments 2-1 to 2-3, the specific surface area of the lithium nickel cobalt manganese oxide as a positive active material affects the impedance, the low-temperature cycling performance, and the high-temperature storage performance of the lithium-ion battery. When the value of the specific surface area falls within the range specified herein, the lithium-ion battery achieves a higher capacity retention rate after cycling at −10° C., a lower thickness expansion rate after storage at 85° C., a lower DCR change rate when cycled at 25° C., and a lower DCR change rate when cycled at 45° C., indicating that the lithium-ion battery incurs a lower impedance and achieves good low-temperature cycling performance and high-temperature storage performance.

It is hereby noted that the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. An electrolyte solution, comprising: an additive A and an additive B;
the additive A comprises at least one selected from the group consisting of a compound of Formula (I-1), a compound of Formula (I-2), and a compound of Formula (I-3): 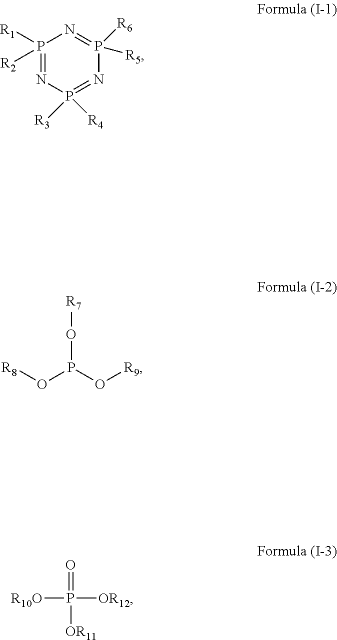
wherein R₁, R₂, R₃, R₄, R₅, and R₆ each are independently selected from a halogen atom, a C₁ to C₁₂ alkyl or a C₁ to C₁₂ alkoxyl; R₇, R₈, and R₉ each are independently selected from a hydrogen atom, a halogen atom, a silyl, a cyano group, an acyloxy, a sulfonyl, a C₁ to C₁₀ alkyl, a C₁ to C₁₀ haloalkyl, a C₂ to C₁₀ alkenyl, a C₂ to C₁₀ haloalkenyl, a C₂ to C₁₀ alkynyl, or a C₂ to C₁₀ haloalkynyl; and R₁₀, R₁₁, and R₁₂ each are independently selected from a hydrogen atom, a halogen atom, a C₁ to C₇ alkyl, a C₁ to C₇ haloalkyl, a C₂ to C₇ alkenyl, a C₂ to C₇ haloalkenyl, a C₂ to C₇ alkynyl, a C₂ to C₇ haloalkynyl, a C₆ to C₁₀ aryl, or a C₆ to C₁₀ haloaryl; and
the additive B comprises at least one selected from the group consisting of lithium bis(trifluoromethanesulfonyl)imide, lithium difluoro (bisoxalato)phosphate, and lithium bis(oxalato) borate.

2. The electrolyte solution according to claim 1, wherein, based on a mass of the electrolyte solution, a mass percentage of the additive A is W₁, and a mass percentage of the additive B is W₂; wherein 0.01≤W₁/W₂≤80, 0.01%≤W₁≤5%, and 0.01%≤ W₂≤6%.

3. The electrolyte solution according to claim 1, wherein the additive A comprises the compound of Formula (I-1); the compound of Formula (I-1) comprises at least one of the following compounds:

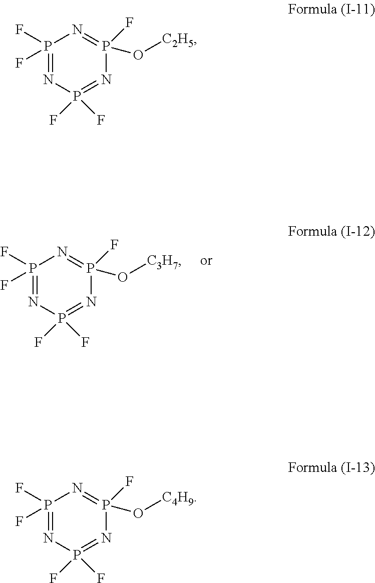

4. The electrolyte solution according to claim 1, wherein the additive A comprises the compound of Formula (I-2); and the compound of Formula (I-2) comprises at least one of the following compounds:

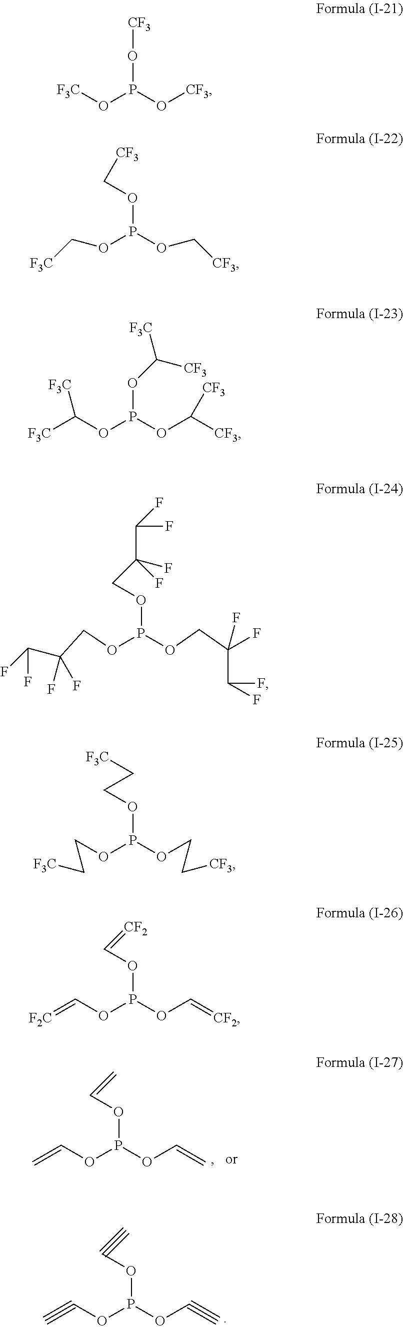

5. The electrolyte solution according to claim 1, wherein the additive A comprises the compound of Formula (I-3); and the compound of Formula (I-3) comprises at least one selected from the group consisting of trimethyl phosphate, triethyl phosphate, triphenyl phosphate, tris(hexafluoroisopropyl) phosphate, tris(trifluoroethyl) phosphate, tris(2-trifluoromethylallyl)phosphate, tris(2-trifluoromethyl-but-3-ynyl)phosphate, and difluoroethyl trifluoroethyl hexafluoroisopropyl phosphate.

6. The electrolyte solution according to claim 1, wherein, based on a mass of the electrolyte solution, the additive A satisfies at least one of the following characteristics:
(1) a mass percentage of the compound of Formula (I-1) is 0.01% to 3%;
(2) a mass percentage of the compound of Formula (I-2) is 0.01% to 2%; or
(3) a mass percentage of the compound of Formula (I-3) is 0.01% to 3%.

7. The electrolyte solution according to claim 1, wherein, based on a mass of the electrolyte solution, the additive B satisfies at least one of the following characteristics:
(1) the additive B comprises the lithium bis(trifluoromethanesulfonyl)imide, and a mass percentage of the lithium bis(trifluoromethanesulfonyl)imide is 0.01% to 4%;
(2) the additive B comprises the lithium difluoro (bisoxalato)phosphate, and a mass percentage of the lithium difluoro (bisoxalato)phosphate is 0.01% to 6%; or
(3) the additive B comprises the lithium bis(oxalato) borate, and a mass percentage of the lithium bis(oxalato) borate is 0.01% to 5%.

8. The electrolyte solution according to claim 1, wherein the electrolyte solution satisfies one of the following characteristics:
(1) the additive A comprises the compound of Formula (I-1) and the compound of Formula (I-2); or
(2) the additive A comprises the compound of Formula (I-2) and the compound of Formula (I-3).

9. The electrolyte solution according to claim 1, wherein the electrolyte solution satisfies one of the following characteristics:
(1) the additive B comprises the lithium bis(trifluoromethanesulfonyl)imide and the lithium difluoro (bisoxalato)phosphate;
(2) the additive B comprises the lithium bis(trifluoromethanesulfonyl)imide and the lithium bis(oxalato) borate; or
(3) the additive B comprises the lithium difluoro (bisoxalato)phosphate and the lithium bis(oxalato) borate.

10. The electrolyte solution according to claim 1, wherein the additive B comprises lithium bis(trifluoromethanesulfonyl)imide, the lithium the difluoro (bisoxalato)phosphate, and the lithium bis(oxalato) borate.

11. A lithium-ion battery, comprising a positive electrode plate, a negative electrode plate, and an electrolyte solution, wherein
the electrolyte solution comprising: an additive A and an additive B;
the additive A comprises at least one selected from the group consisting of a compound of Formula (I-1), a compound of Formula (I-2), and a compound of Formula (I-3): 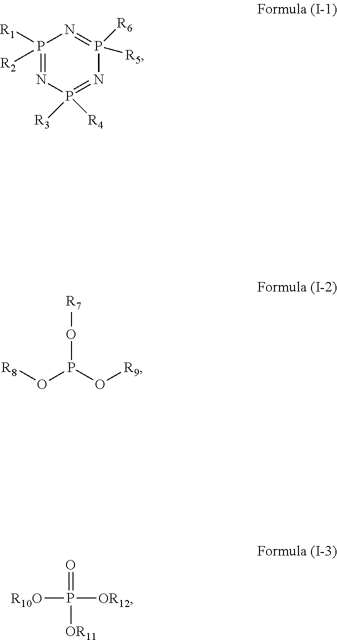
wherein R₁, R₂, R₃, R₄, R₅, and R₆ each are independently selected from a halogen atom, a C₁ to C₁₂ alkyl or a C₁ to C₁₂ alkoxyl; R₇, R₈, and R₉ each are independently selected from a hydrogen atom, a halogen atom, a silyl, a cyano group, an acyloxy, a sulfonyl, a C₁ to C₁₀ alkyl, a C₁ to C₁₀ haloalkyl, a C₂ to C₁₀ alkenyl, a C₇ to C₁₀ haloalkenyl, a C₂ to C₁₀ alkynyl, or a C₂ to C₁₀ haloalkynyl; and R₁₀, R₁₁, and R₁₂ each are independently selected from a hydrogen atom, a halogen atom, a C₁ to C₇ alkyl, a C₁ to C₇ haloalkyl, a C₂ to C₇ alkenyl, a C₂ to C₇ haloalkenyl, a C₂ to C₇ alkynyl, a C₂ to C₇ haloalkynyl, a C₆ to C₁₀ aryl, or a C₆ to C₁₀ haloaryl; and
the additive B comprises at least one selected from the group consisting of lithium bis(trifluoromethanesulfonyl)imide, lithium difluoro (bisoxalato)phosphate, and lithium bis(oxalato) borate; and
the positive electrode plate comprises a positive active material layer, the positive active material layer comprises a positive active material, the positive active material comprises lithium nickel cobalt manganese oxide, and a specific surface area of the lithium nickel cobalt manganese oxide is 0.1 m²/g to 2.0 m²/g.

12. The lithium-ion battery according to claim 11, wherein, based on a mass of the electrolyte solution, a mass percentage of the additive A is W₁, and a mass percentage of the additive B is W₂; wherein 0.01≤W₁/W₂≤80, 0.01%≤W₁≤5%, and 0.01%≤ W₂≤6%.

13. The lithium-ion battery according to claim 11, wherein the additive A comprises the compound of Formula (I-1); the compound of Formula (I-1) comprises at least one of the following compounds:

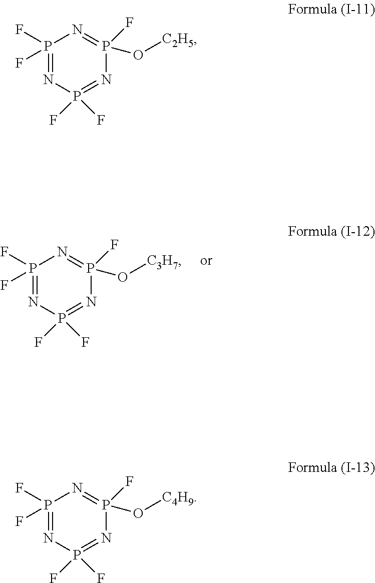

14. The lithium-ion battery according to claim 11, wherein the additive A comprises the compound of Formula (1-2); and the compound of Formula (I-2) comprises at least one of the following compounds:

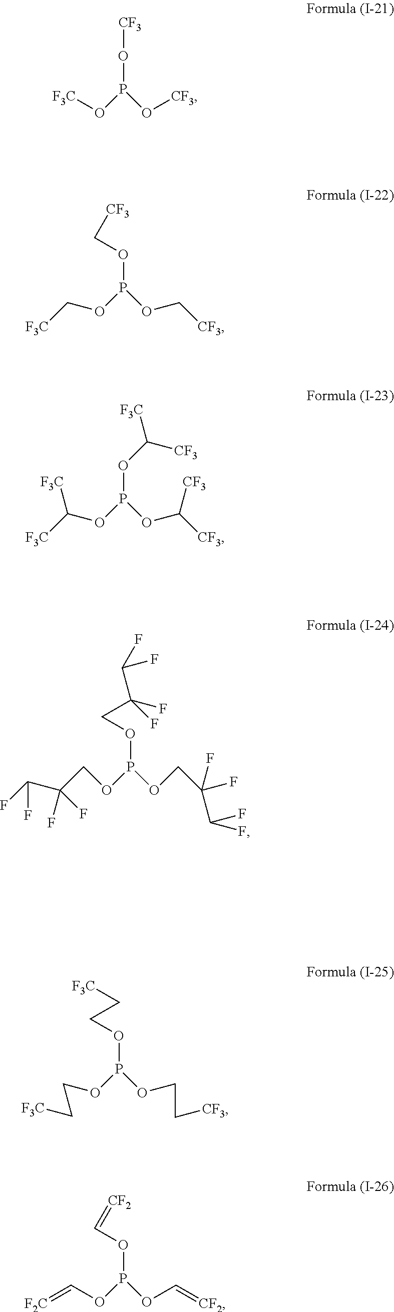

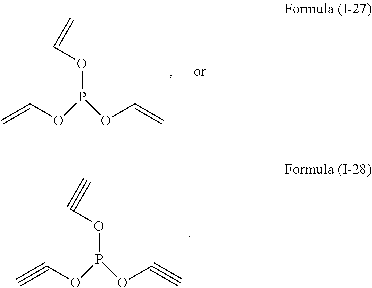

15. The lithium-ion battery according to claim 11, wherein the additive A comprises the compound of Formula (1-3); and the compound of Formula (I-3) comprises at least one selected from the group consisting of trimethyl phosphate, triethyl phosphate, triphenyl phosphate, tris(hexafluoroisopropyl) phosphate, tris(trifluoroethyl) phosphate, tris(2-trifluoromethylallyl)phosphate, tris(2-trifluoromethyl-but-3-ynyl)phosphate, and difluoroethyl trifluoroethyl hexafluoroisopropyl phosphate.

16. The lithium-ion battery according to claim 11, wherein, based on a mass of the electrolyte solution, the additive A satisfies at least one of the following characteristics:
(1) a mass percentage of the compound of Formula (I-1) is 0.01% to 3%;
(2) a mass percentage of the compound of Formula (I-2) is 0.01% to 2%; or
(3) a mass percentage of the compound of Formula (I-3) is 0.01% to 3%.

17. The lithium-ion battery according to claim 11, wherein, based on a mass of the electrolyte solution, the additive B satisfies at least one of the following characteristics:
(1) the additive B comprises the lithium bis(trifluoromethanesulfonyl)imide, and a mass percentage of the lithium bis(trifluoromethanesulfonyl)imide is 0.01% to 4%;
(2) the additive B comprises the lithium difluoro (bisoxalato)phosphate, and a mass percentage of the lithium difluoro (bisoxalato)phosphate is 0.01% to 6%; or
(3) the additive B comprises the lithium bis(oxalato) borate, and a mass percentage of the lithium bis(oxalato) borate is 0.01% to 5%.

18. The lithium-ion battery according to claim 11, wherein the electrolyte solution satisfies one of the following characteristics:
(1) the additive A comprises the compound of Formula (I-1) and the compound of Formula (I-2); or
(2) the additive A comprises the compound of Formula (I-2) and the compound of Formula (I-3).

19. The lithium-ion battery according to claim 11, wherein the additive B comprises the lithium bis(trifluoromethanesulfonyl)imide, the lithium difluoro (bisoxalato)phosphate, and the lithium bis(oxalato) borate.

20. The lithium-ion battery according to claim 11, wherein the lithium-ion battery satisfies at least one of the following characteristics:
(1) a mass percentage of the additive B is 0.01% to 4%; or
(2) a specific surface area of the lithium nickel cobalt manganese oxide is 0.1 m²/g to 1.8 m²/g.
